(19) United States
(12) Patent Application Publication
(10) Pub. No.: US 2013/0021433 A1
(43) Pub. Date: Jan. 24, 2013

(54) OVERVIEW CONFIGURATION AND CONTROL METHOD FOR PTZ CAMERAS

(71) Applicants: AJIT BELSARKAR, Lancaster, PA (US); Michael Yanni, East Petersburg, PA (US)

(72) Inventors: AJIT BELSARKAR, Lancaster, PA (US); Michael Yanni, East Petersburg, PA (US)

(73) Assignees: Robert Bosch GmbH, Stuttgart (DE); Bosch Security Systems Inc., Fairport, NY (US)

(21) Appl. No.: 13/188,424

(22) Filed: Jul. 21, 2011

(51) Int. Cl. H04N 7/18

(52) U.S. Cl. 348/36; 348/E07.085

(57) ABSTRACT

A method of operating a surveillance camera arrangement includes panning a PTZ camera about a pan axis. First images are captured with the camera throughout the panning. A composite panoramic or circular second image is created by stitching together the first images captured during the panning. The user is enabled to select and modify presets, recordings, and/or video analytics profiles within the composite panoramic or circular second image.

### BACKGROUND OF THE INVENTION

1. Field of the Invention

The present invention relates to surveillance cameras, and, more particularly, to surveillance cameras that are able to pan, tilt and zoom.

2. Description of the Related Art

Surveillance camera systems are commonly used by retail stores, banks, casinos and other organizations to monitor activities within a given area. The cameras are often provided with the capability to pan and tilt in order to acquire images over a wide domain. The tilt of the camera generally refers to the pivoting of the camera about a horizontal axis that is parallel to the floor, such that the lens of the camera may tilt between an upwardly pointing position and a downwardly pointing position. The pan of the camera refers to the rotation of the camera about a vertical axis that is perpendicular to the floor, such that the lens may scan from side to side. The cameras may also be able to zoom in order to reduce or enlarge the field of view.

PTZ cameras have a varying field of view and have relevant features. However, the configuration methods for these cameras are mere extensions of the methods used for configuring fixed cameras.

In comparing a PTZ camera and a fixed camera, the field of view of a fixed camera is determined at the time of installation and does not change thereafter. On the other hand, a PTZ camera finds a reference position upon power up and then the PTZ camera can move in pan, tilt and zoom directions. Thus, any point within three-dimensional space may be in the field of view of the PTZ camera, assuming that the panning, tilting and zooming mechanisms have no limitations.

Most of the features of a PTZ camera relate to the video at specific pan, tilt and zoom coordinates. Such features may include presets, tours, record/playback, privacy masks, alarms and video analytics settings. As used herein, the term “preset” may refer to a particular pan, tilt, zoom position of the camera. The camera may stop at a preset at during each tour of the camera. The camera may dwell at the preset for some period of time and continue to capture images at the preset. A playback of a recording of the camera may involve the camera undergoing a predetermined path of pan, tilt and zoom movements. A tour may include panning components of the camera movements spanning 360 degrees or more.

Certain, pan, tilt, zoom locations can be saved as presets. The presets can be recalled on demand or the camera sequentially moves between various presets.

A tour involves the PTZ device repetitively moving to predefined positions in sequence. There may be predefined or fixed time intervals in-between the positions on the tour.

In record/playback, the user records a path involving specific pan, tilt and zoom movements at specific time intervals. Once recorded, the path may be played back once or repetitively.

Privacy masks are areas within a field of view that the system does not allow a viewer to see. That is, privacy masks are used to block out the video from chosen pan, tilt, zoom locations. For example, a window in a house may be covered by a privacy mask.

Alarm inputs can be physical inputs such as sensors, and alarm outputs can be switches and relays. Although alarms may not be related to video, alarms may be attached to specific pan, tilt, zoom positions such as at doors, gates, etc.

Video analytics settings or parameters such as trip wires or sensitive areas may relate to specific pan, tilt, zoom locations. The user may be interested in monitoring certain sensitive areas for activity, such as at doors, gates, etc. Video analytics settings or parameters may be conjointly referred to herein as a “video analytics profile” or an “intelligent video analysis (IVA) profile.”

In currently known methods such as described above for configuring the various features of a PTZ camera, only the video at the current PTZ position is shown to the user. For example, when configuring the privacy masks 16 of FIG. 1 at unique PTZ positions and the preset of FIG. 2, only the current PTZ position is displayed on the display screen. In FIG. 1, the privacy mask is selected or set up at a unique PTZ position. In FIG. 2, only the preset itself is displayed.

These above-described configuration methods, which work well for fixed cameras, however ignore and fail to take advantage of the fact that the PTZ camera can move to any point in the entire three-dimensional space and is not limited to the current field of view. Thus, with the above-described configuration methods, the user does not receive a comprehensive outlook of the entire field of view. For example, he does not know where all the presets are configured; where all the sensitive areas are; or where the alarms are located, for example. Also, with the above-described configuration methods, the user does not know the positions of the parameters relative to each other. It may be beneficial to know the positions of the parameters relative to each other because the number of configurable parameters is generally large. For example, there may be ninety-nine presets, twenty-four masks, and ten analytics profiles.

A problem is that currently known configuration methods of PTZ cameras restrict the user to the current field of view (FOV). This can be constraining for various features of the PTZ cameras. In many cases, the user would like to see where these features are physically located in the larger scene and how the features are separated from each other. For example, the user would like to see where he has defined the FOV presets within the larger scene, and which presets are on a given tour.

What is neither disclosed nor suggested by the prior art is a surveillance camera arrangement that enables the user to see the location of the present FOV, as well as features such as presets, privacy masks, recordings, and video analytics profiles within a panoramic view of the surrounding area. Nor has the idea of being able to control the camera via a panoramic view been suggested by the prior art.

### SUMMARY OF THE INVENTION

The present invention is directed to an overview configuration method for a PTZ camera wherein the method employs a panorama (plain or circular) image. The invention provides a method for controlling, configuring and viewing the features of a typical PTZ device. The user is provided with a representation of the complete possible field of view by a panoramic image and the selected features are mapped to it. The user can view/configure the parameters such as presets, tours, pattern record and playback via the overview configuration method. The user can control the pan, tilt, and zoom movement of the camera via a FOV projection overlaid on the panoramic image. The panoramic image is governed by moving the camera to each required pan, tilt, zoom position; acquiring the image at each position; and stitching all the acquired images together. The various PTZ-dependent features are mapped to this image. The user can then select and modify the features of his interest, such as presets, privacy masks, recordings, video analytics profiles, etc. The PTZ-dependent features can be represented on the panoramic image as a scaled FOV projection.

In one embodiment of an overview configuration method of the present invention for PTZ cameras, the user is presented with a visual representation of the complete possible field of view of the camera. The representation may be in the form of a panoramic image, and the selected features may be mapped to the panoramic image. While viewing the selected features and the panoramic image, the user can view and/or configure the parameters. The panoramic image may be generated by moving the PTZ camera to each required pan, tilt, zoom position; acquiring an image at each of these positions; and stitching together all of the acquired images to form a composite image.

The panoramic image could be created at any time. The user would be able to determine if the image is to be used in the configuration process or saved to a location of their choosing on the computer. Saving images of this type would be useful to get a snapshot of the entirety of the camera's view at the time of the image's creation.

The various features which are dependent upon the pan, tilt, zoom positions may be mapped to the composite image. The user may then be able to select and modify the features he is interested in, such as presets, privacy masks, recordings, video analytics profiles, etc.

In one embodiment of a configuration method of the invention, the user initiates the configuration process, such as by clicking on an on-screen configuration icon, or by pressing a configuration pushbutton, for example. Next, images covering the entire scene within the space are captured at respective panning intervals. These individual images may be stitched together to form a panoramic 360 degree image. On the panoramic 360 degree image, the user may view and/or edit features such as by editing a mask, removing a preset, etc. After the user has viewed and/or edited the features, the user may save the features and their corresponding locations. The user may initiate the saving process by clicking on an on-screen save icon, or by pressing a save pushbutton, for example. Upon the saving process being initiated, the locations corresponding to the saved features may be converted or mapped from the panoramic image to the pan, tilt, zoom coordinates of the PTZ device's coordinate system. Thus, the features may be saved along with their corresponding pan, tilt, zoom coordinates. During subsequent tours of the PTZ device (e.g., PTZ camera), the PTZ device may stop at these saved pan, tilt, zoom coordinates and then execute the corresponding feature (e.g., a preset). Alternatively, the PTZ device may not stop at saved pan, tilt, zoom coordinates, but rather may place a feature at the saved pan, tilt, zoom coordinates (e.g., a privacy mask).

After the configuration is complete, the user may use the panoramic view to control the camera's pan, tilt, and zoom position via a FOV projection on the view. This type of control would be available from hereinafter.

The invention comprises, in one form thereof, a method of operating a surveillance camera arrangement, including panning a PTZ camera about a pan axis. First images are captured with the camera throughout the panning. A composite panoramic or circular second image is created by stitching together the first images captured during the panning. The user is enabled to select and modify presets, recordings, and/or video analytics profiles within the composite panoramic or circular second image.

The invention comprises, in another form thereof, a method of operating a surveillance camera arrangement, including, in response to the user initiating a configuration process, capturing a plurality of discrete images with at least one camera. Each of the discrete images correspond to a different respective field of view. The captured images are combined to thereby form a panoramic image. The panoramic image is displayed. The user is enabled to view, establish and/or edit an operating feature of the at least one camera. The operating feature corresponds to at least one location in the panoramic image. After the enabling step, information defining the feature and the at least one corresponding location is saved.

The invention comprises, in yet another form thereof, a method of configuring a surveillance camera arrangement, including receiving an initiation of the configuration from the user. The camera is used to perform a scanning movement. A plurality of images are captured with the camera. Each of the images is captured at a respective one of a plurality of substantially evenly-spaced locations within the scanning movement. The captured images are merged together to thereby generate a panoramic composite image. The user is enabled to view the composite image. Received from the user is a modification of a feature associated with the panoramic composite image. The feature is saved in memory as modified by the user.

The present invention may take into account that the PTZ camera can move to any point in the entire three-dimensional space, and is not limited to the current field of view. This would be controlled by the user via a FOV projection overlaid on the panoramic image. The camera may move fluidly as the user drags the FOV projection. The camera could also move directly to a pan and tilt position by clicking the FOV to a different location on the panoramic view.

The user may receive a comprehensive outlook of the entire field of view, and may be informed of where all the presets are configured, where all the sensitive areas are, and where the alarms are located.

The user may be informed of the positions of the parameters relative to each other. This may be especially beneficial in view of the number of configurable parameters being generally large, e.g., ninety-nine presets, twenty-four masks, and ten analytics profiles.

The invention may provide a method for faster configuration for setting up all the relevant features in a single session. For example, all the privacy masks can be defined at once.

The invention may provide a high level of flexibility in programming the PTZ device as the user is not restricted to predefined primitives, such as a preset tour.

A still further another advantage is that the method of the invention has a lot of potential for future expansions, and can provide a basis for developing new and useful features such as intelligent video analysis (WA) tour, etc.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a plan view of two privacy masks provided on a display screen of a surveillance camera system of the prior art.

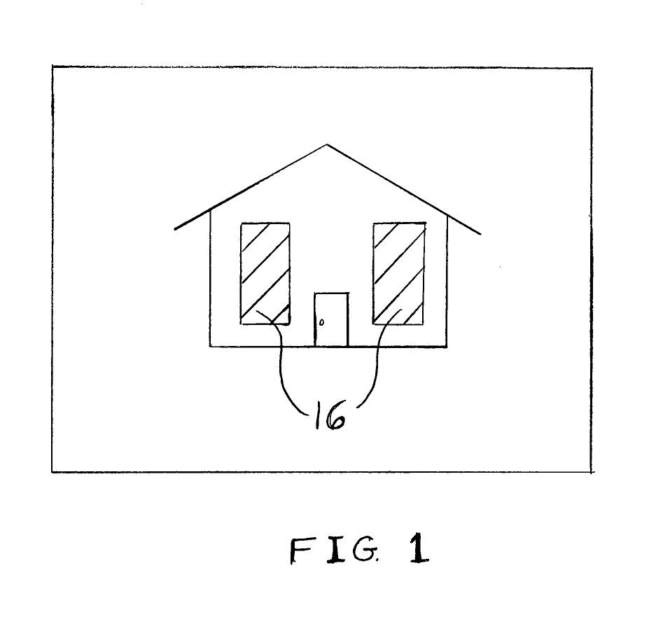

FIG. 2 is a plan view of a preset provided on a display screen of a surveillance camera system of the prior art.

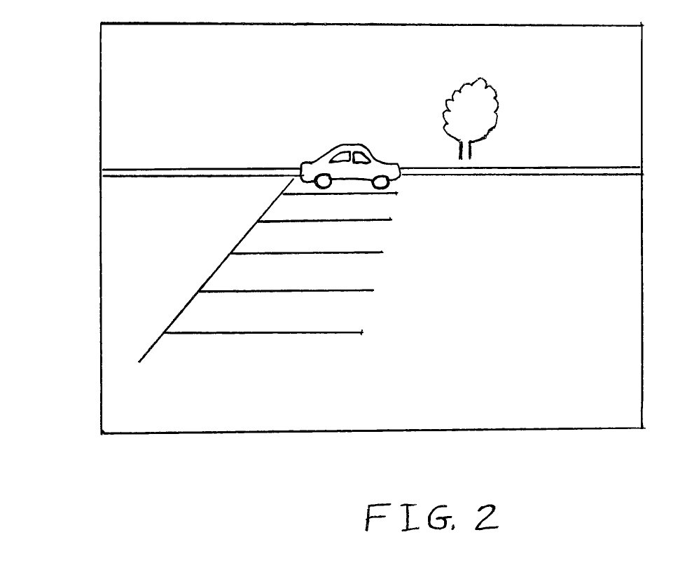

FIG. 3 is a schematic view of a surveillance camera arrangement in accordance with the present invention.

FIG. 4 is a block diagram of the processing device of FIG. 3.

FIG. 5 is a flow chart illustrating one embodiment of a surveillance camera arrangement configuration method of the present invention.

FIG. 6 is a plan view illustrating one embodiment of the invention for configuration of presets on a display screen.

FIG. 7 is a plan view illustrating one embodiment of the invention for configuration of preset tour on a display screen.

FIG. 8 is a plan view illustrating one embodiment of the invention for configuration of privacy masks on a display screen.

FIG. 9 is a plan view illustrating one embodiment of the invention for configuration of record/playback on a display screen.

FIG. 10 is a plan view illustrating one embodiment of the invention for creating a circular panoramic image on a display screen.

FIG. 11 is a flow chart illustrating one embodiment of a method of the present invention for operating a surveillance camera arrangement.

FIG. 12 is a flow chart illustrating another embodiment of a method of the present invention for operating a surveillance camera arrangement.

FIG. 13 is a plan view illustrating one embodiment of the invention for configuration of alarms on a display screen.

FIG. 14 is a plan view illustrating one embodiment of the invention for configuration of IVA profiles on a display screen.

FIG. 15 is a plan view of the circular panoramic image of FIG. 10 including a shape representing a field of view of the camera.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

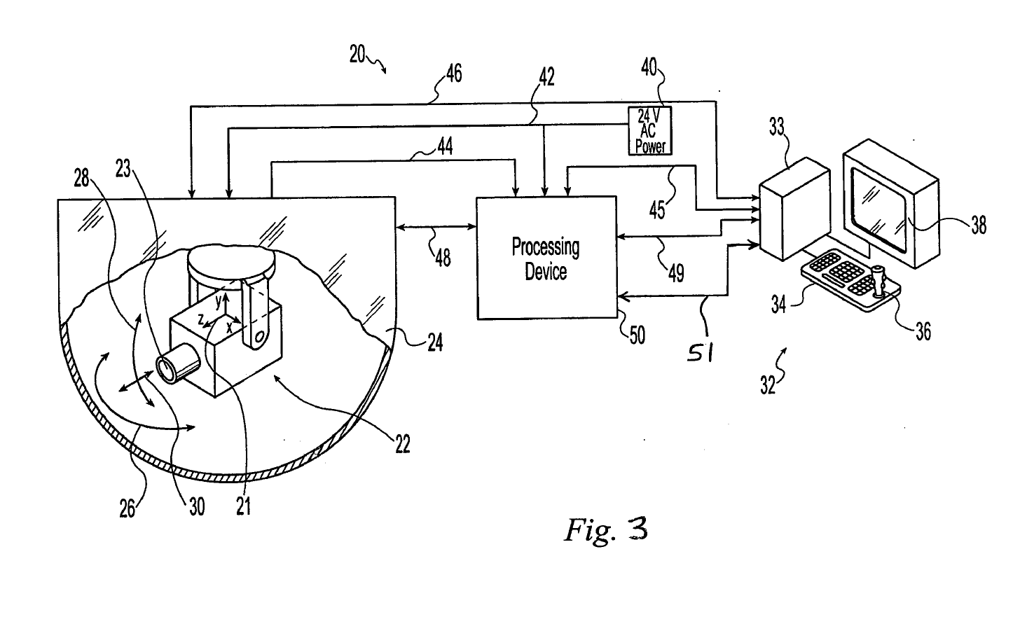

In accordance with the present invention, a surveillance camera arrangement 20 is shown in FIG. 3. Arrangement 20 includes a camera 22 which is located within a partially spherical enclosure 24 and mounted on support 25. Stationary support 25 may take many forms, such as an outwardly extending support arm extending from an exterior edge of a building which may subject the supported camera to unintentional movement resulting from wind, vibrations generated by the camera motors, nearby machinery or a myriad of other sources. Enclosure 24 is tinted to allow the camera to acquire images of the environment outside of enclosure 24 and simultaneously prevent individuals in the environment being observed by camera 22 from determining the orientation of camera 22. Camera 22 includes a controller and motors which provide for the panning, tilting and adjustment of the focal length of camera 22. Panning movement of camera 22 is represented by arrow 26, tilting movement of camera 22 is represented by arrow 28 and the changing of the focal length of the lens 23 of camera 22, i.e., zooming, is represented by arrow 30. As shown with reference to coordinate system 21, panning motion may track movement along the x-axis, tilting motion may track movement along the y-axis and focal length adjustment may be used to track movement along the z-axis. In the illustrated embodiment, camera 22 and enclosure 24 may be an AutoDome® brand camera system, such as the G3 or G4 AutoDome® camera and enclosure, which are available from Bosch Security Systems, Inc., formerly Philips Communication, Security & Imaging, Inc., having a place of business in Lancaster, Pa. The basic, advanced, or other models of the G3 or G4 AutoDome® camera may be suitable for use in conjunction with the present invention. A camera suited for use with present invention is described by Sergeant et al. in U.S. Pat. No. 5,627,616 entitled Surveillance Camera System which is hereby incorporated herein by reference.

Arrangement 20 also includes a head end unit 32. Head end unit 32 may include a video switcher or a video multiplexer 33. For example, the head end unit may include an Allegiant® brand video switcher available from Bosch Security Systems, Inc., such as a LTC 8500 Series Allegiant® Video Switcher which provides inputs for up to sixty-four cameras and may also be provided with eight independent keyboards and eight monitors. Head end unit 32 includes a keyboard 34 and joystick 36 for operator input. Head end unit 32 also includes a display device in the form of a monitor 38 for viewing by the operator. A twenty-four volt a/c power source 40 is provided to power both camera 22 and a processing device 50 that is operably coupled to both camera 22 and head end unit 32.

The illustrated arrangement 20 is a single camera application, however, the present invention may be used within a larger surveillance system having additional cameras which may be either stationary or moveable cameras or some combination thereof to provide coverage of a larger or more complex surveillance area. One or more analog or digital recording devices may also be connected to head end unit 32 to provide for the recording of the video images captured by camera 22 and other cameras in the system.

Camera 22 may include an image-capturing device such as a charge coupled device (CCD) that acquires a four-sided (e.g., rectangular) CCD video image. Processing device 50 may identify or select at least a portion of the CCD image to be displayed on a screen of monitor 38 for viewing by an operator of system 20.

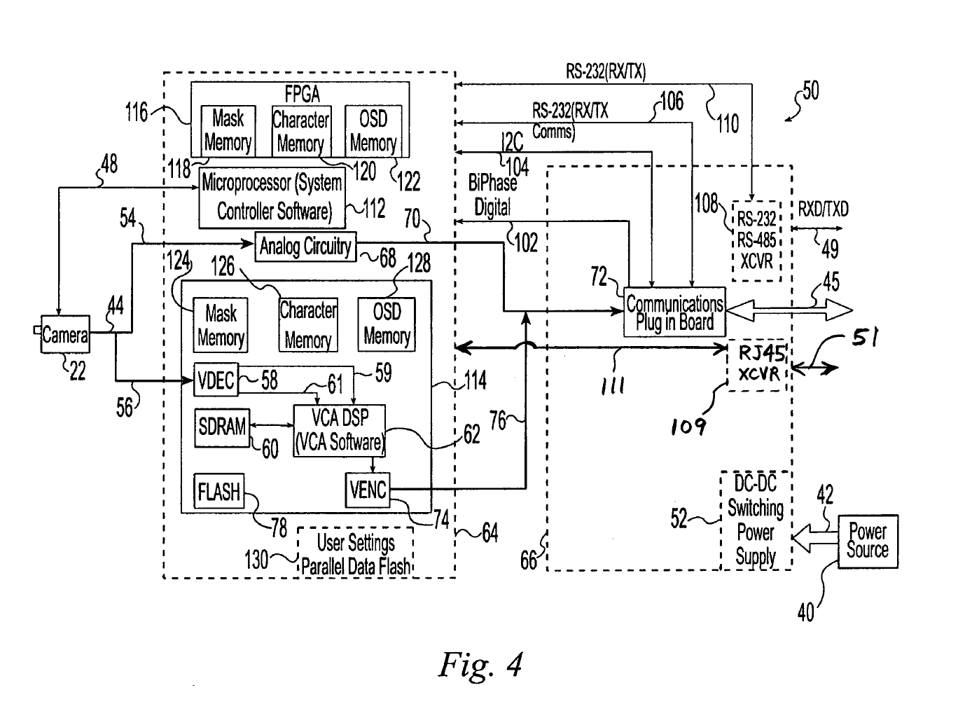

The hardware architecture of processing device 50 is schematically represented in FIG. 4. In the illustrated embodiment, processing device 50 includes a system controller board 64 in communication with a power supply/IO board 66. A power line 42 connects power source 40 to converter 52 in order to provide power to processing device 50. Processing device 50 receives a raw analog video feed from camera 22 via video line 44, and video line 45 is used to communicate video images to head end unit 32. In the illustrated embodiment, video lines 44, 45 are coaxial, seventy-five ohm, one Volt peak-to-peak and include BNC connectors for engagement with processing device 50. The video images provided by camera 22 can be analog and may conform to NTSC or PAL standards, variations of NTSC or PAL standards, or other video standards such as SECAM. When processing device 50 is inactive, i.e., turned off, video images from camera 22 can pass through processing device 50 to head end unit 32 through analog video line 54, analog circuitry 68, analog video line 70 and communications plug-in board 72. Board 72 can be a standard communications board capable of handling biphase signals associated with a Bosch physical interface and communications protocol for sending setup and control data to a pan and tilt or to an AutoDome®. Board 72 may be capable of handling a coaxial message integrated circuit (COMIC) Bosch proprietary control data over video protocol. Board 72 may be capable of handling a bi-directional communications protocol such as Bilinx for sending two-way communication over video links, such as by sending setup and control data to an AutoDome® over the video signal.

Via another analog video line 56, a video decoder/scaler 58 receives video images from camera 22, converts the analog video signal to a digital video signal, and separates the luminance (Y) component from the chrominance (U, V) components of the composite, color video signal. Video decoder/scaler 58 sends a full resolution (unscaled) digital video signal 59 to a video capture port of the VCA DSP 62. Video decoder/scaler 58 also sends a scaled (sub-sampled horizontally by four and vertically by four) QCIF image 61 produced by its scaler function to a second video capture port of VCA DSP 62. SDRAM memory 60 connects directly to VCA DSP 62 and provides volatile memory to store and execute the VCA software after boot, and to provide temporary memory storage. This temporary storage includes, but is not limited to, the storage of video buffers. The video stabilization algorithm described above with reference to FIGS. 3 and 4 is performed in VCA DSP 62. The adjusted display image is sent via a DSP video display port to video encoder 74 where the chrominance and luminance components of the digital video signal are re-combined and the video signal is converted to an analog composite video signal. The resulting annotated analog video signal is sent via analog video lines 76 and 70 to communications plug-in board 72, which then sends the signal to head end unit 32 via video line 45.

In the illustrated embodiment, video input to system controller board 64 is limited to about 1.1 Volt peak-to-peak. If the video signal exceeds 1.1 Volt peak-to-peak without a proportional increase in synchronization level, then the signal may be clipped to about 1.1 Volt peak-to-peak. If the video signal including the synchronization level is increased, then the video decoder/scaler 58 will attempt to compensate by reducing the video gain in order to regulate the synchronization level. However, alternative embodiments having a greater or lesser capacity may also be employed with the present invention. Processor 62 may be a TMS320DM642 programmable Video/Imaging Fixed-Point Digital Signal Processor available from Texas Instruments. At start up, processor 62 loads a bootloader program. The boot program then copies the VCA application code from a memory device such as flash memory 78 to SDRAM 60 for execution. In the illustrated embodiment, flash memory 78 provides four megabytes of memory and SDRAM 60 provides thirty-two megabytes of memory. In the illustrated embodiment, at most four MBytes of the thirty-two MBytes of SDRAM will be required to execute code, and the remaining twenty-eight MBytes of SDRAM is available for video buffers and other use.

In the embodiment shown in FIG. 4, system controller board 64 is connected to communications plug-in board 72 via a biphase digital data bus 102, an I2C data bus 104, and an RS-232 data bus 106. System controller board 64 is connected to an RS-232/RS-485 compatible transceiver 108 via RS-232 data bus 110. A line 49, which can be in the form of an RS-232 debug data bus, communicates signals from head end unit 32 to processing device 50. The signals on line 49 can include signals that can be modified by processing device 50 before being sent to camera 22. Such signals may be sent to camera 22 via line 48 in communication with microprocessor 112. Microprocessor 112 can operate system controller software and can communicate with VCA DSP 62 by means of a sixteen-bit interface such as the DSP's Host Peripheral Interface (HPI-16). Thus, VCA components such as VCA DSP 62 can send signals to camera 22 via microprocessor 112 and line 48.

System controller board 64 is connected to an RJ-45 compatible Ethernet transceiver 109 via RJ-45 Ethernet cable 111. A line 51, which can be in the form of an RJ-45 Ethernet cable 111, communicates signals from head end unit 32 to processing device 50. The signals on cable 51 can include signals that can be modified by processing device 50 before being sent to camera 22. Such signals may be sent to camera 22 via line 48 in communication with microprocessor 112. Camera 22 may have Ethernet capability, and the capturing of the images and control may be performed via Ethernet.

System controller board 64 may also include a field programmable gate array 116 including a mask memory 118, a character memory 120, and an on screen display (OSD) memory 122. Similarly, VCA components 114 may include a mask memory 124, a character memory 126, and an on screen display (OSD) memory 128. These components may be used to mask various portions of the image displayed on screen 38 or to generate textual displays for screen 38. Finally, system controller board 64 can include a parallel data flash memory 130 for storage of user settings.

In the illustrated embodiment, the only necessary commands conveyed to processing device 50 that are input by a human operator are on/off commands and PTZ commands. However, even these on/off commands and PTZ commands may be automated in alternative embodiments. Such on/off commands and other serial communications are conveyed via bi-phase line 46 between head end unit 32 and camera 22, and between processing device 50 and camera 22 via line 48.

In the illustrated embodiment, processing device 50 is mounted proximate camera 22. However, processing device 50 may also be mounted employing alternative methods and at alternative locations. Alternative hardware architecture may also be employed with processing device 50. Such hardware should be capable of running the software and processing at least approximately five frames per second for good results. It is also noted that by providing processing device 50 with a sheet metal housing, the mounting of processing device 50 on or near a PTZ camera is facilitated, and system 20 may thereby provide a stand alone embedded platform which does not require a personal computer-based image stabilization system. If desired, however, the present invention may also be employed using a personal computer based system.

Processing device 50 can perform several functions, including capturing video frames acquired by camera 22, identifying a stationary feature in the video frames, determining the intended change in the camera FOV based upon signals sent to or received from camera 22, identifying a stationary feature and determining the actual change in the camera FOV, comparing the intended and actual change in the camera FOV to determine the magnitude of the image translations resulting from the unintentional motion of the camera and selecting display image coordinates to counteract the translations resulting from the unintentional motion of the camera. Processing device 50 may also be used to perform an automated tracking function. For example, processing device 50 may also provide an automated tracking system wherein processing device 50 is used to identify moving target objects in the FOV of the camera and then generate control signals which adjust the pan, tilt and zoom settings of the camera to track the target object and maintain the target object within the FOV of the camera.

Arrangement 20 as described above may be used in conjunction with an overview configuration method of the present invention. The user may be presented with a representation of the complete possible field of view by a panoramic image and the selected features are mapped to the panoramic image. The user can view and/or configure the parameters.

The panoramic image may be generated by moving the camera to each required pan, tilt, zoom position, acquiring an image at each position, and stitching together all of the acquired images into a composite panoramic or circular image. The various features that are dependent upon pan, tilt, zoom position may be mapped to the composite image. The user can then select and modify the features of his interest, such as presets, privacy masks, recordings, video analytics profiles, etc.

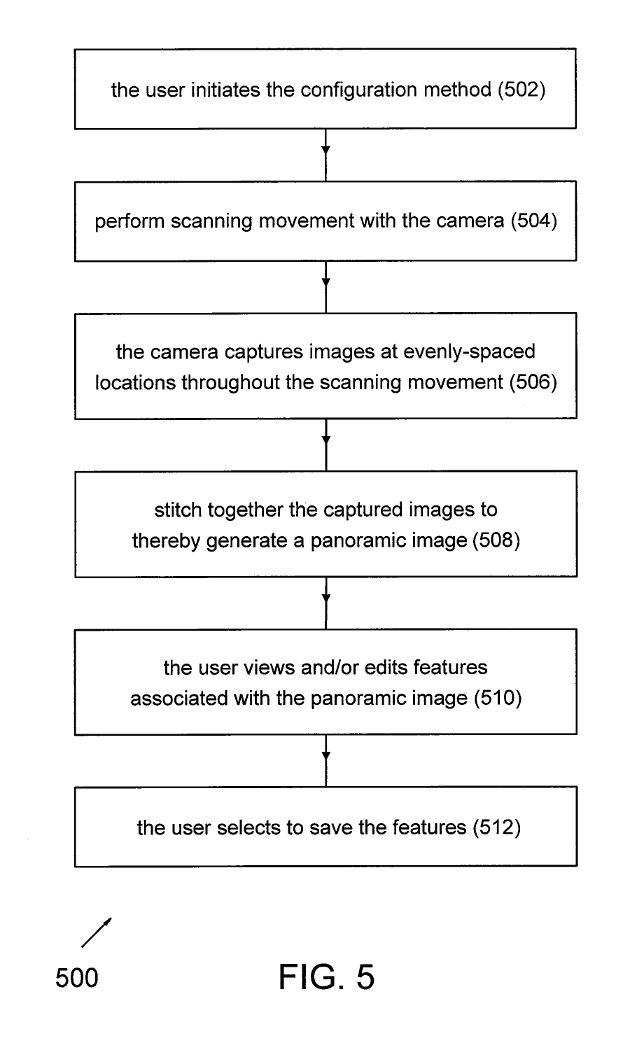

One embodiment of a configuration method 500 of the present invention is illustrated in FIG. 5. In a first step 502, the user initiates the configuration method. For example, the user may use a computer mouse or joystick 36 to click on an on-screen configuration icon. Alternatively, the user may initiate configuration by navigating through an on-screen menu of options, or by pressing a dedicated pushbutton on keyboard 34.

In a next step 504, the camera performs scanning movement. That is, the camera may undergo a panning motion that may also include components of tilting motion and zoom motion. In one embodiment, the panning motion may span approximately 360 degrees about a vertical axis.

Next, in step 506, the camera captures images at evenly-spaced locations throughout the scanning movement. The images may be captured over the Ethernet interface. In one embodiment, the distance or space between the evenly-spaced locations may depend upon the width of the field of view of the camera. For example, assume that in a very specific embodiment the width of the field of view of the camera is sixty degrees. In this case, the camera may undergo sixty degrees of panning motion between the locations at which the camera captures images. Thus, after capturing the first image and panning sixty degrees five separate times, capturing an image after each sixty degree panning motion, the camera encompasses 360 degrees of panning movement. Each of the six captured images is sixty degrees wide in the panning direction, and together cover the entire 360 degrees surrounding the camera. Each of the captured images may be horizontally adjacent two other ones of the six captured images.

In step 508, the captured images are stitched or merged together to thereby generate a panoramic image. To continue the example given above in association with step 506, assuming that each captured image has two opposing vertically-oriented edges, each of the six adjacent pairs of vertically-oriented edges may be merged together to thereby form a continuous, seamless, and uninterrupted 360 degree panoramic composite image. It is possible for each of the captured images to be substantially triangular such that each of the captured images meet at a point directly above the camera. In this case, the composite image is hemispherically-shaped, or, more generally, frusto-spherically-shaped.

In a next step 510, the user views and/or edits features associated with the panoramic image. For example, the user may edit a mask, remove a preset, modify a video recording, and/or modify a video analytics profile.

In a final step 512, the user selects to save the features. For example, the user may use a computer mouse or joystick 36 to click on an on-screen icon for saving the features as edited in step 510. Alternatively, the user may initiate the saving of modified features by navigating through an on-screen menu of options, or by pressing a dedicated pushbutton on keyboard 34. In one embodiment, the features represented on the panoramic image may be converted back to the pan, tilt, and zoom coordinates of the PTZ device's coordinate system and saved in memory.

In a specific embodiment, method 500 may further include performing a tour with the camera including panning, tilting and/or zooming movements. The tour of the camera may be stopped at a set of pan, tilt, and zoom coordinates. After the stopping step, the feature is placed at the set of pan, tilt, and zoom coordinates.

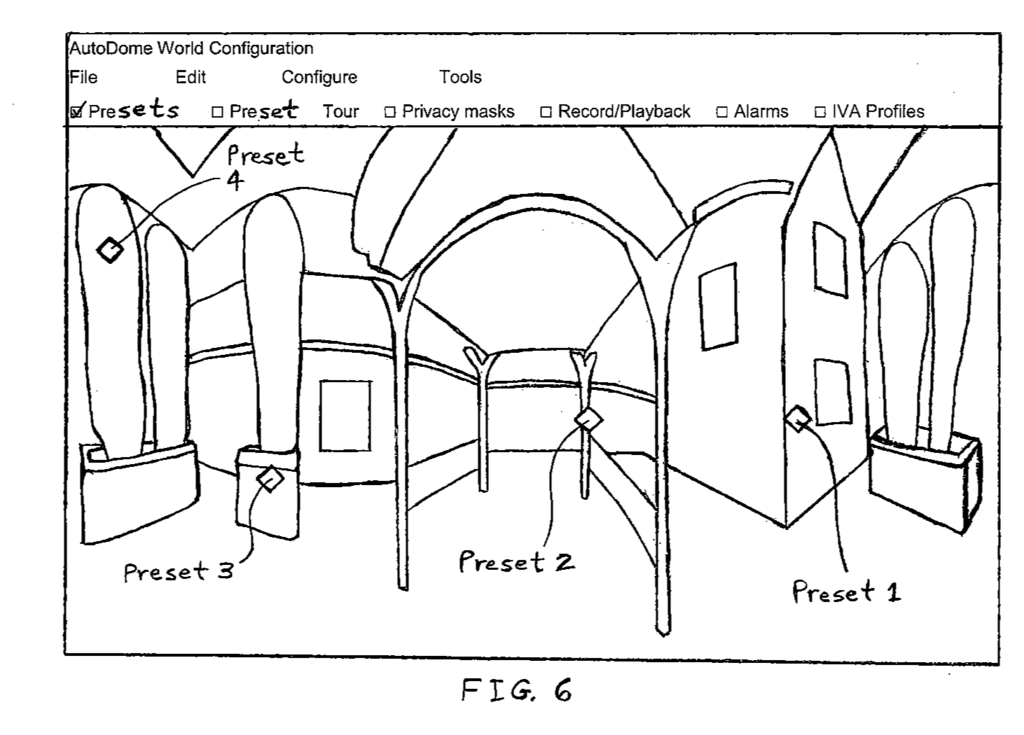

In FIGS. 6-10 are illustrated various embodiments of the invention for configuring and viewing the privacy masks, presets, preset tour, record/playback, etc. FIG. 6 is a plan view illustrating one embodiment of the invention for configuration of presets on a display screen. As can be seen in FIG. 6, the user has selected four presets, including preset 1, preset 2, preset 3, and preset 4. As shown near the top of the display screen, the user is presented with four selectable options, namely, “file,” “edit,” “configure,” and “tools.” Similarly to a WINDOWS environment, the user may use a computer mouse to position a cursor above any one of the four options and then left-click on the mouse in order to select the option. In the horizontal bar below the four options, the user is presented with six other options, including “presets,” “preset tour,” “privacy masks,” “record/playback,” “alarms,” and intelligent video analysis profiles, i.e., “IVA profiles.” As can be seen in FIG. 6, the “Presets” box has been checked by the user, signifying that the user is currently configuring presets on-screen. In the course of configuring the presets, the user may specify the Pan, Tilt and Zoom coordinates of interest by using the graphical user interface (GUI). The user can also specify camera functionality values such as Focus and Iris modes. These values may be converted by the user interface software to the actual coordinates of the PTZ camera and saved as a preset.

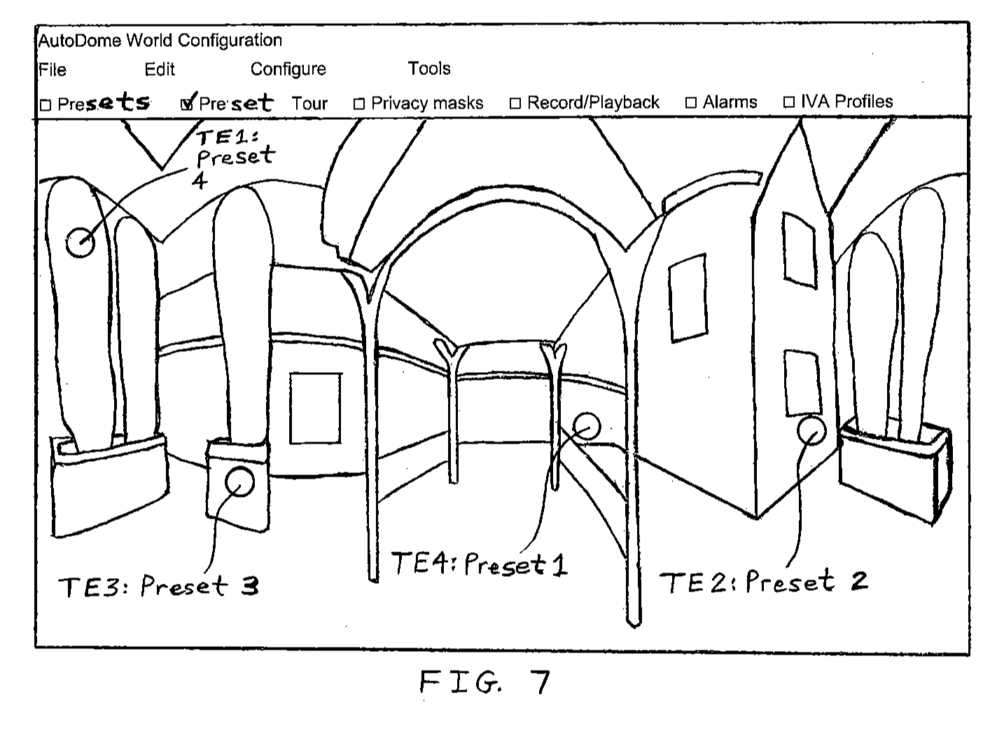

FIG. 7 is a plan view illustrating one embodiment of the invention for configuration of a preset tour on a display screen. As can be seen in FIG. 7, the user has selected four preset stops on the tour, the sequential order of the preset stops, and the dwell time to be spent at each preset stop. As shown near the top of the display screen, the user is presented with the same options as in FIG. 6. As can be seen in FIG. 7, the “Preset Tour” box has been checked by the user, signifying that the user is currently configuring a preset tour on-screen. In the course of configuring the preset tour, the user may configure a sequence of presets. By using the GUI, the user may specify the presets on the tour, the order of the presets, and the dwell time between presets.

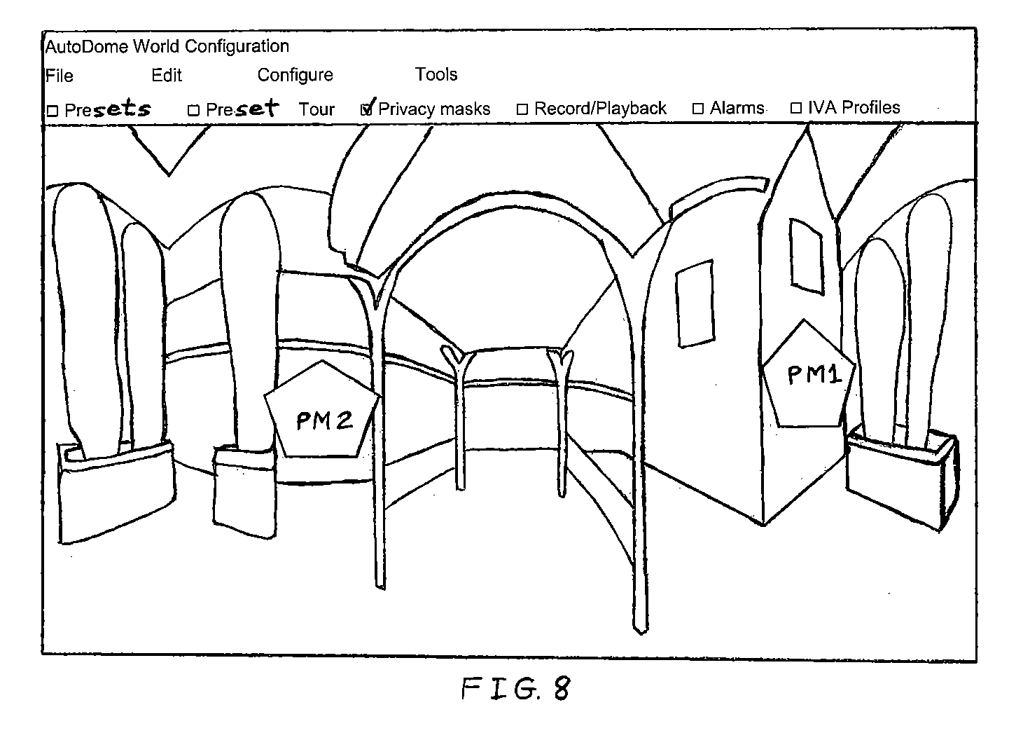

FIG. 8 is a plan view illustrating one embodiment of the invention for configuration of privacy masks on a display screen. As can be seen in FIG. 8, the user has configured two privacy masks. As shown near the top of the display screen, the user is presented with the same options as in FIGS. 6-7. As can be seen in FIG. 8, the “Privacy masks” box has been checked by the user, signifying that the user is currently configuring privacy masks on-screen. In the course of configuring the privacy masks, the user may mask out certain areas in the field of view. The privacy masks may prevent an operator of the surveillance camera arrangement from viewing or recording the portions of the image that are within the privacy masks. In the example image shown in FIG. 8, privacy masks PM1 and PM2 cover windows of the building. The windows may be covered by the privacy masks because there may be people within the building who have an expectation of privacy and do not want to be seen through the windows. By using the GUI, the user may draw the masks with different sizes, shapes and styles. The GUI may convert the coordinates to the real coordinates of the PTZ camera.

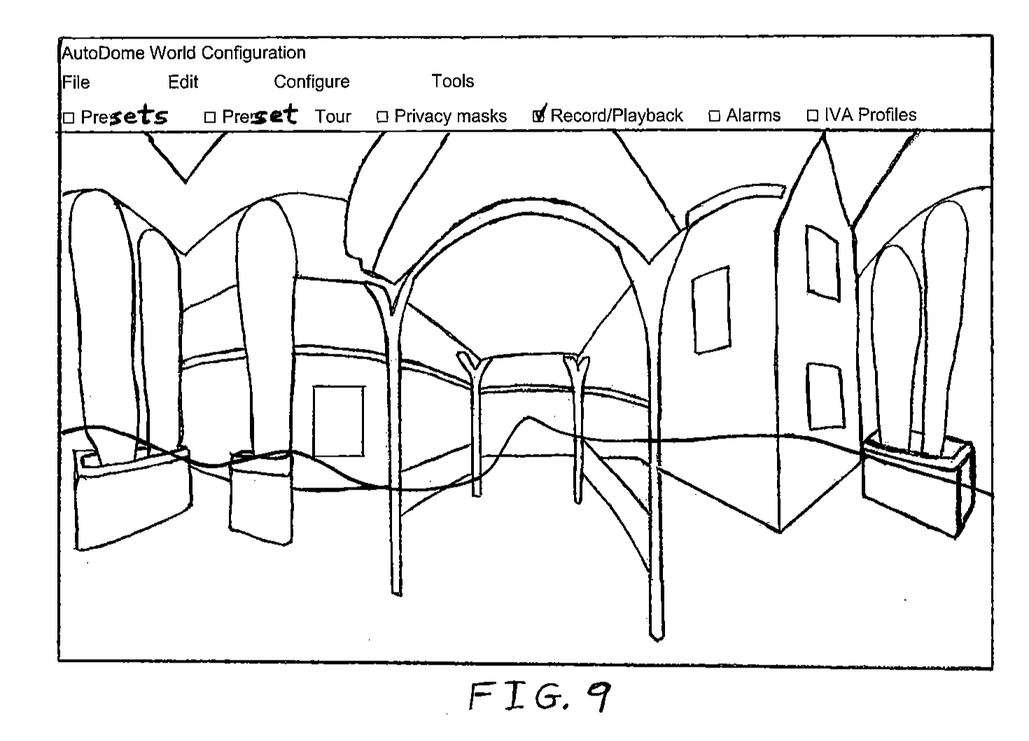

FIG. 9 is a plan view illustrating one embodiment of the invention for configuration of record/playback on a display screen. As can be seen in FIG. 9, the user has configured a panning and tilting path for the camera to follow, as embodied by a serpentine line on the screen. As shown near the top of the display screen, the user is presented with the same options as in FIGS. 6-8. As can be seen in FIG. 9, the “Record/Playback” box has been checked by the user, signifying that the user is currently configuring recording and playback on-screen. By using record/playback, the user records positions and commands. These commands may then later be executed in the same sequence as specified by the user. By using the GUI, the user may represent graphically where the camera should be going (e.g., where the camera's field of view should be as determined by panning and tilting movements) during recording. A panoramic image, such as embodied in FIG. 9, may provide a comprehensive overall view or illustration of where the camera will be directed during the tour. The GUI may convert or translate the coordinates to the real coordinates of the PTZ camera.

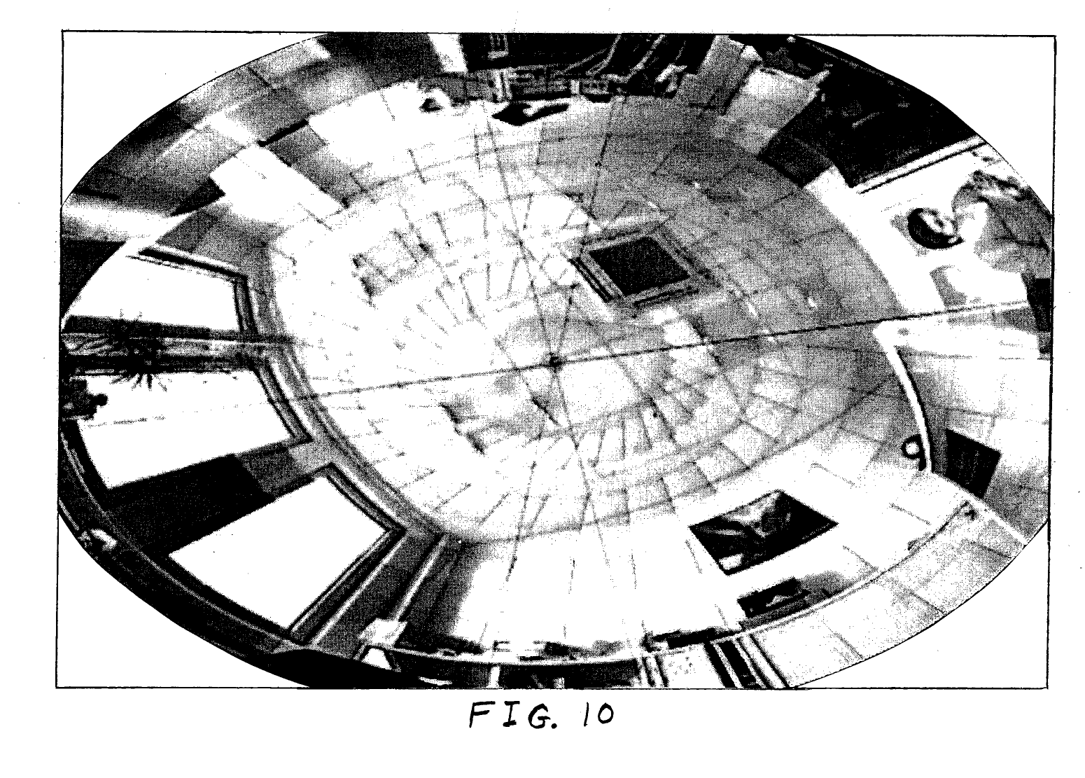

FIG. 10 is a plan view illustrating one embodiment of the invention for creating a circular panoramic image on a display screen. In one embodiment, the present invention includes creation of the panoramic image, and mapping of PTZ coordinates between the panoramic and non-panoramic images. Methods that may be used for formation of the panoramic image include image stitching and stereographic projections. The example of FIG. 10 illustrates a circular stitched image. It is to be understood that any of the methods described herein with reference to the rectangular panoramic images of FIGS. 6-9 and 13-14 may be similarly performed in conjunction with a circular panoramic image as shown in FIG. 10.

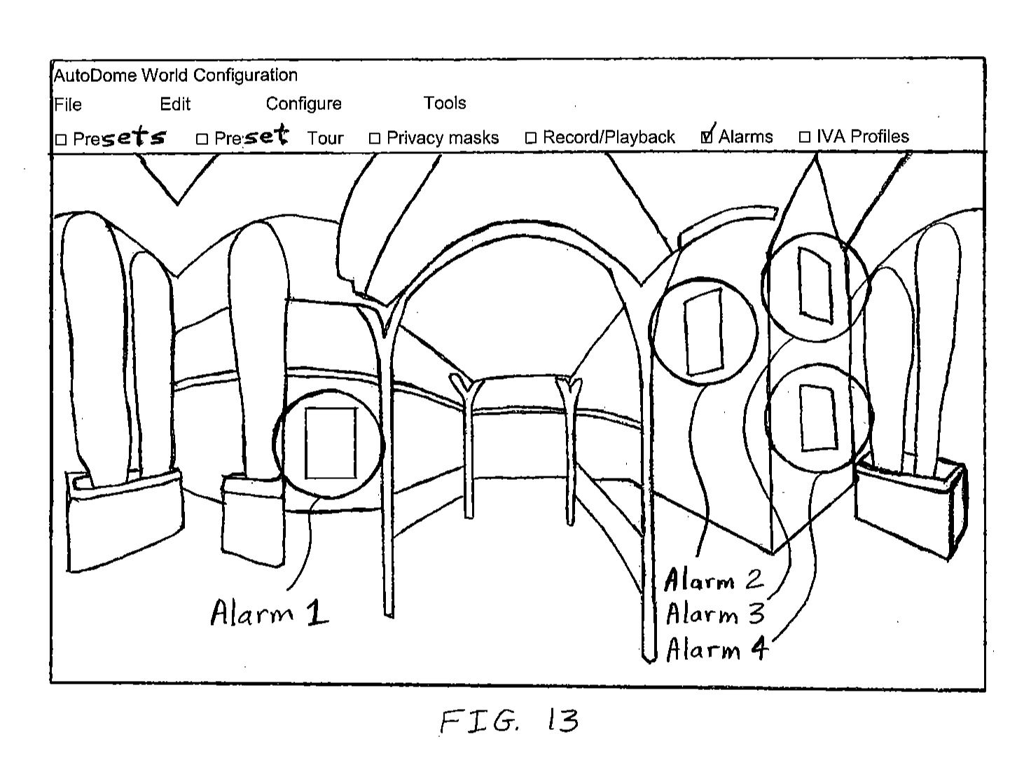

FIG. 13 is a plan view illustrating one embodiment of the invention for configuration of alarm areas on a display screen. As can be seen in FIG. 13, the user has configured four alarm areas relating to specific pan, tilt, zoom locations. As shown near the top of the display screen, the user is presented with the same options as in FIGS. 6-9. As can be seen in FIG. 13, the “Alarms” box has been checked by the user, signifying that the user is currently configuring Alarms on-screen. In the course of configuring the Alarms, the user may select certain areas in the field of view. If the video surveillance arrangement detects any movement within any of the sensitive areas during selected hours of the day in which there should be no movement, an alarm signal may be transmitted to police or other authorities. In the example image shown in FIG. 13, circular alarm areas 1-4 cover windows of a building within the monitored area. The sensitive areas may be treated as such only during certain hours of the day in which there should be no people within the building. By using the GUI, the user may draw the outlines of the sensitive areas with different sizes, shapes and styles, other than circular as shown. The GUI may convert the coordinates to the real coordinates of the PTZ camera.

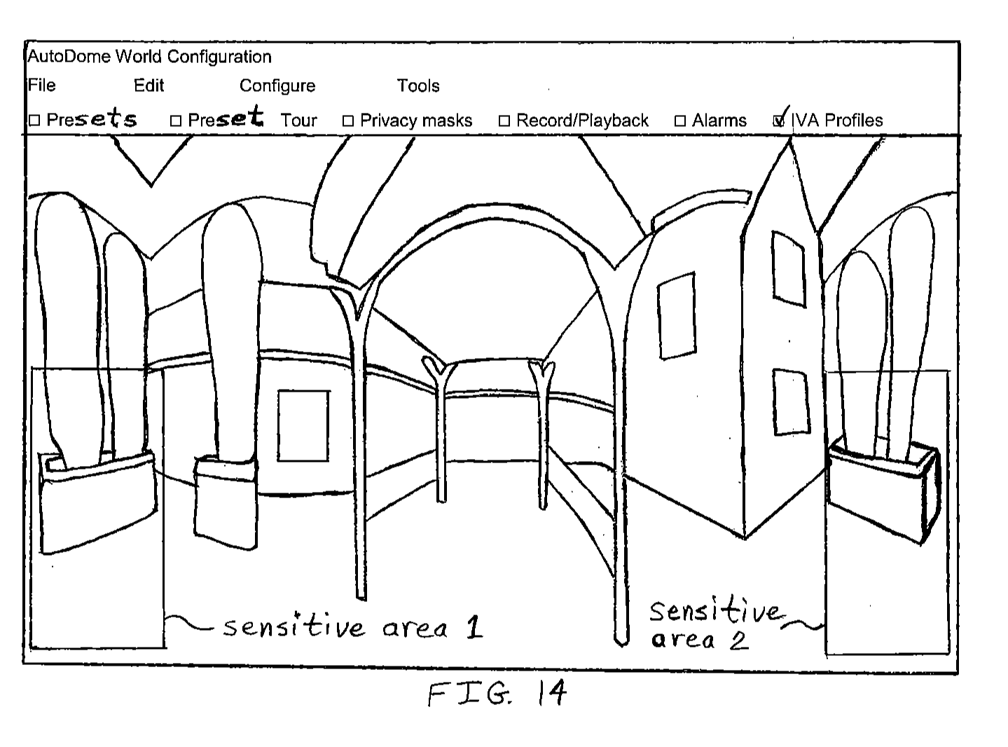

FIG. 14 is a plan view illustrating one embodiment of the invention for configuration of video analytics profiles on a display screen. As can be seen in FIG. 14, the user has configured two sensitive areas relating to specific pan, tilt, zoom locations. In general, the user may be interested in monitoring certain sensitive areas for activity, such as at doors, gates, etc. As shown near the top of the display screen, the user is presented with the same options as in FIGS. 6-9 and 13. As can be seen in FIG. 14, the “IVA Profiles” box has been checked by the user, signifying that the user is currently configuring IVA profiles on-screen. In the course of configuring the WA profiles, the user may select certain areas in the field of view. If the video surveillance arrangement detects any movement within either of the sensitive areas during selected hours of the day in which there should be no movement, monitoring personnel may be notified, such as by audible signals and/or on-screen text messages. In the example image shown in FIG. 14, rectangular sensitive areas 1 and 2 cover ends of the monitored area through which an intruder may enter the panoramic image. By using the GUI, the user may draw the outlines of the sensitive areas with different sizes, shapes and styles, other than rectangular as shown. The GUI may convert the coordinates to the real coordinates of the PTZ camera.

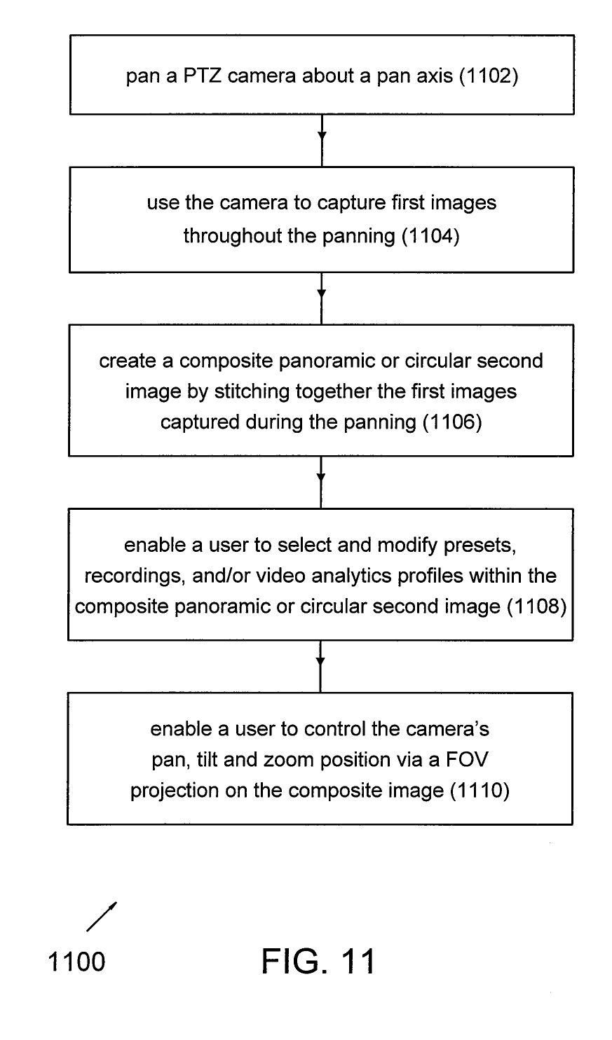

One embodiment of a method 1100 of the present invention for operating a surveillance camera arrangement is illustrated in FIG. 11. In a first step 1102, a PTZ camera is panned about a pan axis. For example, PTZ camera 22 (FIG. 3) may be panned about a pan axis in the form of the y-axis of coordinate system 21.

In a next step 1104, first images are captured with the camera throughout the panning. For example, the image of FIG. 6 may be formed of a plurality of images (e.g., approximately between three and eight images) captured by a camera at spaced-apart panning positions of the camera throughout a panning movement by the camera.

Next, in step 1106, a composite panoramic or circular second image is created by stitching together the first images captured during the panning. That is, the composite panoramic image of FIG. 6 may be created by stitching together side-by-side, spaced-apart images captured by the camera in step 1104 during panning movement of the camera.

Next, in step 1108, the user is enabled to select and modify presets, recordings, and/or video analytics profiles within the composite panoramic or circular second image. For example, as shown in FIGS. 6-7, the user may select and modify presets and their dwell times within a composite panoramic image; as shown in FIG. 9, the user may select and modify a recorded tour within a composite panoramic image; and, as shown in FIG. 14, the user may select and modify trip wires or sensitive areas relating to specific pan, tilt, zoom locations. Alternatively, the user may select and modify presets, recordings and video analytics within a circular image, as shown in FIG. 10.

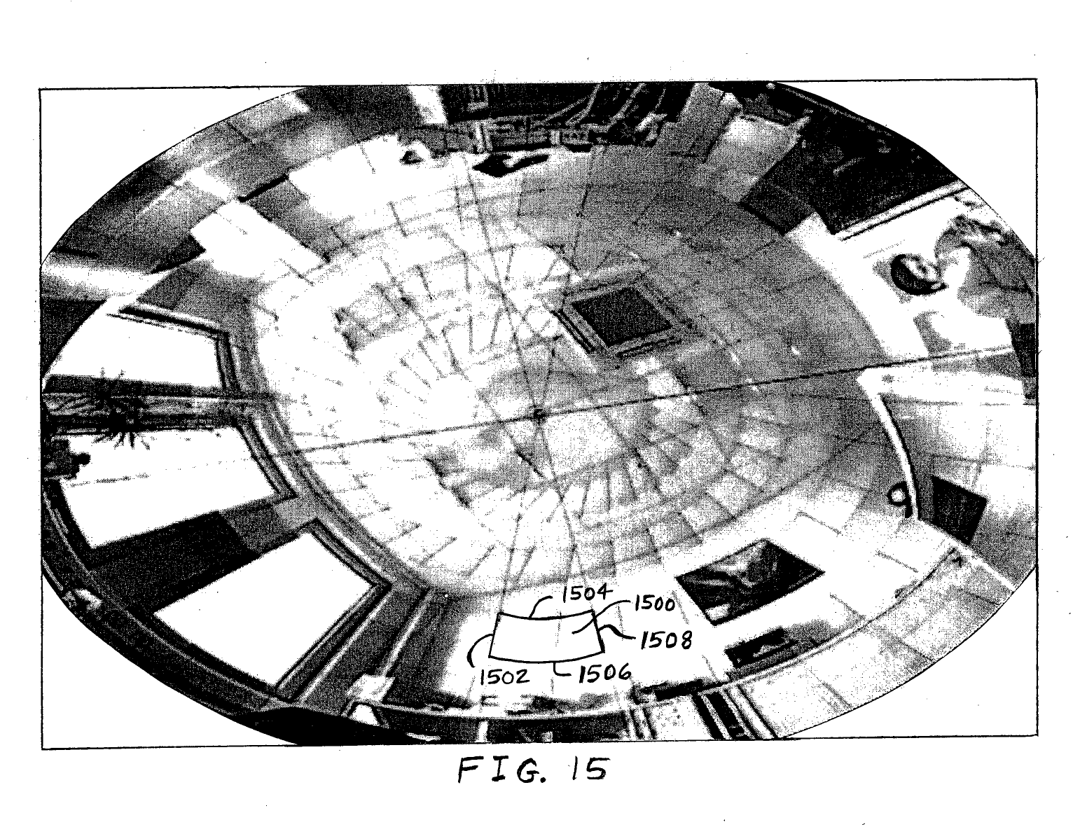

In a final step 1110, the user is enabled hereinafter to control the camera's pan, tilt, and zoom position via a FOV projection on the composite image as shown in FIG. 15. This FOV projection is scaled to represent the actual FOV of the camera in relation to its location on the composite image. The user can drag the FOV projection across the composite image which causes the camera to move accordingly. The composite image may be clicked to instantly move the FOV projection to a location on the composite image which causes the camera to directly pan and tilt to the location accordingly. The user can drag the edges of the FOV projection to cause the camera to zoom in and out accordingly.

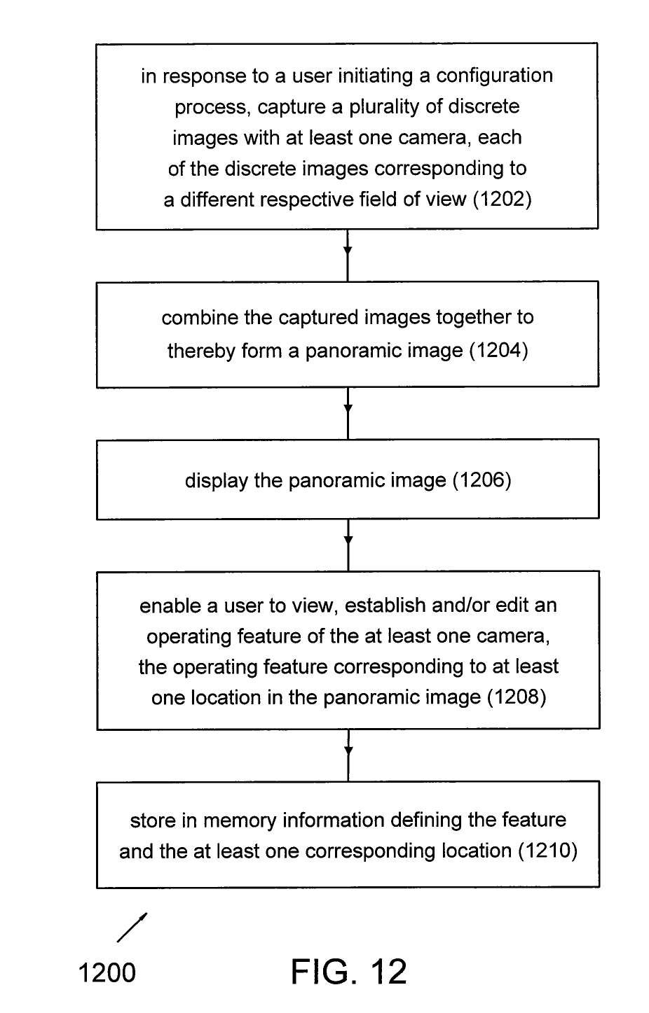

Another embodiment of a method 1200 of the present invention for operating a surveillance camera arrangement is illustrated in FIG. 12. In a first step 1202, in response to the user initiating a configuration process, a plurality of discrete images are captured with at least one camera. Each of the discrete images corresponds to a different respective field of view. For example, the image of FIG. 6 may be formed of a plurality of discrete images (e.g., approximately between three and eight discrete images) captured by a camera at spaced-apart panning positions (e.g., spaced-apart fields of view) of the camera. In response to the user clicking a “configuration” icon or button, the camera may go through a panning movement in which the camera captures the images at horizontally spaced-apart locations.

In a next step 1204, the captured images are combined together to thereby form a panoramic image. That is, the panoramic image of FIG. 6 may be created by stitching together the side-by-side, horizontally spaced-apart images that were captured in step 1202 by the camera during the panning movement of the camera.

Next, in step 1206, the panoramic image is displayed. That is, the panoramic image may be displayed on a monitor or display screen as shown in FIG. 6.

In step 1208, the user is enabled to view, establish and/or edit an operating feature of the at least one camera. The operating feature corresponds to at least one location in the panoramic image. For example, as shown in FIG. 6, the user is enabled to view, establish and/or edit presets in images captured by the camera, the presets corresponding to the locations identified in FIG. 6; as shown in FIG. 7, the user is enabled to view, establish and/or edit presets tours in images captured by the camera, the stops on the preset tours corresponding to the locations identified in FIG. 7; as shown in FIG. 8, the user is enabled to view, establish and/or edit privacy masks in images captured by the camera, the privacy masks corresponding to the locations identified in FIG. 8; as shown in FIG. 9, the user is enabled to view, establish and/or edit record/playback features in images captured by the camera, the record/playback features corresponding to the locations of the serpentine path marked in FIG. 9; as shown in FIG. 13, the user is enabled to view, establish and/or edit alarm areas in images captured by the camera, the alarm areas corresponding to the locations identified in FIG. 13; and, as shown in FIG. 14, the user is enabled to view, establish and/or edit sensitive areas in images captured by the camera, the sensitive areas corresponding to the locations identified in FIG. 14.

In a final step 1210, after the enabling step, information defining the feature and the at least one corresponding location is stored in memory. For example, information defining the user-created features shown in FIGS. 6-9 and 13-14 may be recorded or stored in parallel data flash memory 130.

According to one embodiment of the invention, the panoramic image is completed within a few seconds after the user clicks the configuration button. In able to facilitate such responsiveness, the camera may be restricted to only a few zoom positions.

There may be memory constraints involved with the invention. Where the panoramic image is generated may determine the memory limitation. In one embodiment, the panoramic image is generated in the personal computer (PC) of the surveillance camera arrangement.

FIG. 15 illustrates an embodiment in which a shape 1500 that represents a scaled version of the real field of view (FOV) of the camera is projected onto the panoramic view of FIG. 10. The FOV projection 1500 may be moved by the user via mouse click and dragged by the center of the projection. Edges 1502, 1504, 1506 and 1508 of projection 1500 may automatically bend to conform to the distortion of the panoramic view as projection 1500 is dragged over the panoramic view. Additionally, projection 1500 may grow larger and smaller in size, while still conforming to the panoramic view, as the user zooms the camera in and out.

As the FOV projection 1500 is moved, the camera may physically move in correspondence with the projection's location and size on the panoramic image. The camera may also zoom in and out to follow the zooming in and out of projection 1500 on the display screen. Thus, FOV projection 1500 may enable full pan, tilt, and zoom movements to be conveyed to the camera. In contrast to known camera control methods that include a physical or digital representation of a joystick, FOV projection 1500 may enable instant movement to a pan and tilt position. In another embodiment, camera movement may be initiated by, and may follow, a single mouse click that may instantly move the FOV projection to the screen location clicked in the panoramic view. In another embodiment, zoom control may be implemented by clicking and dragging one of edges 1502, 1504, 1506, 1508 of FOV projection 1500 radially inward and outward, similar to resizing an application's window on a computer.

In another embodiment, a FOV projection may be used as a way of representing a preset, tour path and stopping positions, record/playback path, alarm inputs, and/or video analytics positions on the panoramic view. The FOV projection may show or indicate the associated actual FOV of the camera. For example, if a preset is recalled, or the position in which an alarm input is triggered, the FOV projection may show the actual FOV of the camera at the preset or at the position in which the alarm input is triggered.

While this invention has been described as having an exemplary design, the present invention may be further modified within the spirit and scope of this disclosure. This application is therefore intended to cover any variations, uses, or adaptations of the invention using its general principles.

What is claimed is:

1. A method of operating a surveillance camera arrangement, the method comprising the steps of:
panning a PTZ camera about a pan axis;
capturing first images with the camera substantially throughout the panning;
creating a composite panoramic or circular second image by stitching together said first images captured during the panning,
enabling a user to select and modify presets, recordings, and/or video analytics profiles within the composite panoramic or circular second image; and
enabling the user to control the pan, tilt, and zoom movement of the camera via locations on the composite panoramic or circular second image.

2. The method of claim 1 wherein the user selects and modifies each said preset, recording, and/or video analytics profile at a corresponding location within the composite panoramic or circular second image.

3. The method of claim 2 wherein, during subsequent tours of the camera, the method comprising the further step of executing a corresponding said preset, recording, and/or video analytics profile at each said location.

4. The method of claim 3 comprising the further step of stopping the camera at each said location before executing the corresponding preset, recording, and/or video analytics profile at each said location.

5. A method of operating a surveillance camera arrangement comprising the steps of:
in response to a user initiating a configuration process, capturing a plurality of discrete images with at least one camera, each of the discrete images corresponding to a different respective field of view;
combining the captured images to thereby form a panoramic image;
displaying the panoramic image;
enabling the user to view, establish and/or edit an operating feature of the at least one camera, the operating feature corresponding to at least one location in the panoramic image; and
after the enabling step, saving information defining the operating feature and the at least one corresponding location.

6. The method of claim 5 wherein the operating feature comprises a mask or a preset.

7. The method of claim 5 wherein the saving step is performed in response to the user initiating the saving step.

8. The method of claim 5 comprising the further step of converting the at least one location to pan, tilt, zoom coordinates of the camera, the converting step being performed in response to the user initiating the saving step.

9. The method of claim 8 comprising the further steps of:
performing a tour with the camera; and
executing a corresponding said operating feature at each said pan, tilt, zoom coordinate.

10. The method of claim 9 comprising the further step of stopping touring movement of the camera at each of the pan, tilt, zoom coordinates, each said stopping step occurring before a corresponding said executing step.

11. A method of configuring a surveillance camera arrangement comprising the steps of:
receiving an initiation of the configuring from a user;
using a camera to perform a scanning movement;
capturing a plurality of images, each of the images being captured at a respective one of a plurality of substantially evenly-spaced locations within the scanning movement;
merging together the captured images to thereby generate a panoramic composite image;
enabling the user to view the composite image;
receiving from the user a modification of a feature associated with the panoramic composite image; and
saving the feature as modified.

12. The method of claim 11 comprising the further steps of:
performing a tour with the camera;
stopping the tour of the camera at a set of pan, tilt, and zoom coordinates; and
after the stopping step, placing the feature at the set of pan, tilt, and zoom coordinates.

13. The method of claim 11 wherein the receiving step includes detecting the user using a computer mouse or joystick to click on an on-screen configuration icon.

14. The method of claim 11 wherein the receiving step includes detecting the user navigating through an on-screen menu of options, or by pressing a dedicated pushbutton on a keyboard.

15. The method of claim 11 wherein the scanning movement comprises the camera undergoing a palming motion that also includes components of tilting motion and zoom motion, the panning motion spanning approximately 360 degrees about a vertical axis.

16. The method of claim 11 wherein a distance between the evenly-spaced locations depends upon a width of a field of view of the camera.

17. The method of claim 11 wherein each of the captured images includes two opposing vertically-oriented edges, the merging step comprising merging together adjacent pairs of said vertically-oriented edges to thereby form a continuous, seamless, and uninterrupted 360 degree panoramic composite image.

18. The method of claim 11 wherein the modification of the feature associated with the panoramic composite image comprises editing a mask, removing a preset, modifying a video recording, and/or modifying a video analytics profile.

19. The method of claim 11 wherein the saving step comprises saving a location of the feature within the panoramic composite image.

20. The method of claim 19, comprising the further step of converting the location to pan, tilt, and zoom coordinates of the camera's coordinate system, the saving step including saving the pan, tilt, and zoom coordinates in memory.
